(19) United States
(12) Patent Application Publication
(10) Pub. No.: US 2025/0313767 A1
(43) Pub. Date: Oct. 9, 2025

(54) FULLY MODULARLY ASSEMBLED BOTTOM-FEED PYROLYSIS REACTOR AND MULTI-PRODUCT CO-GENERATION SYSTEM

(71) Applicant: HARVESTGREEN 4H2 INC., Ottawa (CA)

(72) Inventors: Maopei CUI, Ottawa (CA); Xiaoxia LI, Xuzhou City (CN); Yongkui ZHU, Xuzhou City (CN)

(73) Assignee: HARVESTGREEN 4H2 INC., Ottawa, ON (CA)

(21) Appl. No.: 18/772,719

(22) Filed: Jul. 15, 2024

(30) Foreign Application Priority Data
Apr. 3, 2024 (CN) 202410401593.6
Apr. 3, 2024 (CN) 202420680859.0

(51) Int. Cl. C10J 3/42; C10J 3/52

(52) U.S. Cl. CPC C10J 3/42; C10J 3/52; C10J 2200/09; C10J 2200/31

(57) ABSTRACT

A fully modularized, bottom-feed type pyrolysis reactor includes a reactor vessel, a feeding unit, an integrated grate, and an ash/char discharge unit. The reactor vessel includes detachable upper and lower vessels. The integrated grate is rotatable and integrated to an air inlet unit, feeding unit, and discharge unit. A water-cooled cooling and stirring pipe is mounted on a top face of the integrated grate, and an ash/char discharge unit is located at the bottom of the integrated grate. Ash/char is discharged through discharge gate unit, addressing the problems of inconvenient transportation, installation of the pyrolysis reactor, and imprecise temperature control. Manufactured in a modular fashion, the electrical and monitoring systems are pre-assembled and comprehensively tested before transportation to the site, reducing installation time by 90% while ensuring installation quality and allowing for various orientation configurations to meet customers' on-site requirements without altering the overall design of the reactor.

### TECHNICAL FIELD

This disclosure relates to the field of energy, particularly renewable bioenergy, and more particularly to a completely modularly assembled bottom-feed pyrolysis reactor and multi-product co-generation system.

### BACKGROUND

Biomass pyrolysis refers to the thermal chemical conversion technology in which biomass is heated to 250-700° C. in the absence of oxidants (such as air, oxygen, water vapor, etc.) or with limited oxygen. Through thermal chemical reactions, large molecules of biomass (lignin, cellulose, and hemicellulose) are decomposed into smaller molecules of fuel substances (solid biochar, combustible gas, and bio-oil). From the perspective of chemical reactions, biomass undergoes complex thermal chemical reactions during pyrolysis, including molecular bond breaking, isomerization, and small molecule polymerization. (Zhao Tinglin, Wang Peng, Deng Dajun, etc. Current status and prospects of biomass pyrolysis research [J]. New Energy Industry, 2007, 5:54-60).

The products of biomass pyrolysis are combustible pyrolysis gas and solid biomass char, both of which are products suitable for energy applications. In addition to being used as heating fuel, pyrolysis gas can also be further reformed into raw materials for power generation and the synthesis of green liquid fuels. Biomass char, besides being used as fuel, also has many added values. It is used as fuel in metal smelting, food and light industries, as a reducing agent in electric furnace smelting, and as a covering agent to protect metals from oxidation during metal refining. In the chemical industry, it is commonly used as raw material for carbon disulfide and activated carbon. Due to the Chinese government's prohibition of wood charcoal production, the market for biomass char is now extensive.

Chinese patent CN201220748018.6 discloses a vertical pyrolysis reactor. It includes a reactor vessel, a feeding device, a biomass gas outlet at the top of the reactor, an ash discharge device at the bottom of the reactor, and a grate inside the reactor. The feeding device is located at the bottom of the reactor, and the outlet of the feeding device is located at the center of the bottom of the reactor.

Patent Application CN201210590914.9, titled “A Precisely Controlled Vertical Pyrolysis Reactor,” also discloses a reactor comprising a reactor vessel, a feeding device, a biomass gas outlet at the top of the reactor, an ash discharge device at the bottom of the reactor, and a grate inside the reactor. The feeding device is located at the bottom of the reactor, and the outlet of the feeding device is located at the center of the bottom of the reactor. By adopting a bottom-center feeding method, the problem of uneven material distribution, one of the three major bottlenecks that have long plagued biomass pyrolysis reactors, is solved. An agglomeration breaking device is installed in the pyrolysis reactor, forming an organic combination with the rotating grate. The operating speed of the grate can be precisely adjusted to control the discharge rate. Precise control of pyrolysis reaction is achieved by controlling the feeding rate, discharge rate, solid material pile height, air feed rate, air distribution, reaction temperature, etc. The ash discharge of the pyrolysis reactor is more stable and continuous, significantly improving production reliability. The design of the feeding device's position and its coordination with the agglomeration breaking device can effectively process biomass with a size of up to about 10 cm continuously.

Patent Application CN202011483354.8, titled “A Grate and Pyrolysis Reactor,” discloses a grate and pyrolysis reactor, comprising a grate body and at least one stirring member. The grate body is configured for rotatable installation, and the stirring member is fixedly installed on the stirring surface of the grate body. The stirring member is configured to be fixedly installed, and the grate body is free to rotate relative to the stirring member. When the reactor operates, grate body and the stirring member simultaneously act on the material and ash accumulation, making it difficult for bridging to occur inside the reactor. The stirring member of this application has a flow channel, and its interior is cooled by a cooling medium. Heat exchange between the cooling medium and the material and gas inside the reactor can effectively reduce the temperature inside the reactor, thereby effectively controlling the degree of agglomeration inside the reactor and avoiding the formation of agglomerates.

There remains a need for an improved pyrolysis reactor that overcomes at least some of the disadvantages of the prior art reactors. Specifically, the above-mentioned vertical pyrolysis reactors all have large equipment volumes, which makes it difficult to transport over long distances, and difficult to install on site. The on-site installation time is long, and the construction period and quality are difficult to control, thus causing many disadvantages in practical applications, such as transportation being inconvenient, the local temperature of the materials in the reactor being too high, the agglomeration, on-site installation takes a long time and the quality is difficult to control, etc.

### SUMMARY OF EMBODIMENTS

In order to solve the technical problems of vertical pyrolysis reactors in the prior art, such as inconvenient transportation, long installation period, difficulty in controlling the installation quality, the excessive local temperature of the materials in the furnace, potential agglomerations, etc., which are difficult to accurately control, this application proposes a completely modularly assembled bottom-feed pyrolysis reactor and multi-production cogeneration system.

The technical solutions adopted by the present invention to solve the technical problems are:

The invention provides a completely modularly assembled bottom-feed pyrolysis reactor, which includes: a separately installed reactor vessel, which includes a detachable upper vessel and a lower vessel; a feeding unit, the feeding unit is arranged at the lower vessel, and the feeding unit is integrated with an air inlet unit, a discharge gate unit, and an ash/char discharge unit to an integrated grate. The integrated grate is rotatably arranged inside the lower vessel and is sleeved on the feeding pipe of the feeding device. A cooling unit fixedly connected to the reactor vessel is arranged above a material moving surface of the integrated grate. A cooling stirring pipe is provided, a water inlet and a water outlet of the cooling stirring pipe are fixed on the reactor vessel. At the same time, the integrated grate is connected to the air inlet unit. In addition to being integrated with the above-mentioned feeding unit, the integrated grate is also integrated with the air inlet unit, which can accurately control the air inlet to ensure accurate pyrolysis reaction. The air inlet unit also cools key parts of the integrated grate through specific guided channels to ensure that the integrated grate can operate stably and for a long time. The integrated grate is also integrated with the ash/char discharge device. The integrated grate integrates multiple functions such as feeding, air inlet, rotation, ash/char discharge, coke breaking, etc. It is the core component of the reactor to complete the core functions, maximizing integration, improve the level of assembly and quality control. There is an agglomeration breaking unit at the junction of the bottom part of the integrated grate and the lower vessel. It can judge whether an agglomeration is formed based on the integrated grate motor's current, and change the integrated grate speed to achieve agglomeration breaking. The agglomeration breaking can be controlled during operation. System judgment and execution are completed automatically; an agglomeration discharge device, which is fixed on the lower vessel by integrating with the integrated grate, is arranged at the bottom of the integrated grate, and is integrated with the feed material unit and the integrated grate. A discharge gate unit is provided, which is arranged between the integrated grate and the ash/char discharge device, so that the ash is completely reacted on the material moving surface of the integrated grate, or alternatively, the biomass char obtained by precisely controlling the reaction time and reaction temperature passes through the discharge gate and then enters the ash/char discharge hopper of the ash/char discharge unit.

Further, a circulating water channel for cooling water is formed in the vessel wall of the lower vessel.

Further, the water inlet of the cooling stirring tube is arranged on the lower vessel, and the water outlet of the cooling stirring tube is arranged on the upper vessel.

Further, the connection point between the top of the lower vessel and the upper vessel gradually narrows, and an arched protrusion portion protruding into the reactor vessel is formed at the gradually narrowing diameter. This narrowing can facilitate the mixing of pyrolysis gases generated at different times and secondary reactions to obtain pyrolysis gas products with stable composition. Further, the discharge gate unit includes: a flange ring, the flange ring is connected to the bottom of the lower vessel; a plurality of discharge gate plates, which are arranged horizontally and along the flange ring, radial movement to block the channel between the material moving surface of the integrated grate and the ash/char discharge hopper of the ash/char discharge unit; a plurality of filling angle plates, the filling angle plates are fixed on the inner ring of the flange ring. The filling angle plate is filled at the circular strip-shaped outlet surfaces of the two valve plates.

Further, the vertical projection of the filling corner plate is an isosceles triangle, the bottom line of the filling corner plate is connected to the flange ring, and the two waist lines of the filling corner plate are directed toward the center of the flange ring. extending and closing, correspondingly, the end of the discharge gate plate is formed with a straight angle that matches the waistline shape of the filling angle plate.

Further, each discharge gate plate is driven by a separate motor or cylinder. When the discharge gate plate is driven by a motor, a nut is fixed on the discharge gate plate, and a screw rod is fixed on the output shaft of the motor. The screw rod cooperates with the nut. The discharge gate unit uses multiple gate plates that can move horizontally to complete the closing control of the circular strip outlet surface.

Further, it also includes a platform frame body, which is arranged at the work site to erect the reactor vessel. The support legs of the frame body are configured to be connected in sections, and the platform frame body can be connected with the lower vessel of reactor. The lower vessel, the feeding unit, the integrated grate, the ash/char discharge unit and the discharge gate unit are integrated to achieve modular assembly.

Further, a shut-off valve is arranged on the pyrolysis gas outlet pipe of the upper vessel, and the shut-off valve includes: a valve plate, the sealing portion of the valve plate facing the outlet of the pyrolysis gas outlet pipe of the upper vessel; a valve stem, The valve stem pushes the valve plate away from or close to the outlet of the pyrolysis gas outlet pipe of the upper vessel.

Furthermore, the top of the reactor vessel is also equipped with a vent pipe, which can ensure the safety of the unit in emergency conditions. The vent pipe is connected to the scrubbing pool.

Further, the corresponding joints of the reactor vessel, the feeding unit, the integrated grate, the ash/char discharge unit and the discharge gate unit are all circular ring-shaped fits, so that modular assembly can be realized in any directions horizontally.

Further, the three-dimensional space required to be occupied by the lower vessel of the reactor vessel, the platform frame body, the feeding unit, the integrated grate, the ash/char discharge unit, and the discharge gate unit after being pre-assembled and integrated into one body is less than or equal to the loading space of the loaded vehicle, so that the loaded vehicle meets the requirements for road transportation.

Another aspect of the present invention also provides a multi-production co-generation system, including the above-mentioned completely modularly assembled bottom-feed pyrolysis reactor.

Further, it includes a combustion chamber and a plurality of the completely modularly assembled bottom-feed pyrolysis reactors, one or two of the completely modularly assembled bottom-feed pyrolysis reactors are in standby, and the rest of the above-mentioned fully modularly assembled bottom-feed pyrolysis reactors operate normally at the same time, thereby achieving complete redundancy and ensuring that the load required by the customer will not be affected when one or two pyrolysis reactors are out of service due to either maintenance or emergencies, similar to the combination of coal pulverizers and the boilers in a thermal power plant. The realization of redundancy, the use of different biomass feedstock for each pyrolysis reactor, and the adjustment of whether to produce biochar or burn out within each pyrolysis reactor are inevitable requirements for the commercialization of biomass energy.

Based on the above technical solution, the technical effects that the present invention can achieve are:

The completely modularly assembled bottom-feed pyrolysis reactor of the present invention has a modular design as a whole and can be pre-assembled in the workshop to improve quality control. The reactor vessel is made detachable to facilitate loading and transportation. There is a cooling stirring tube fixedly connected to the reactor vessel above the stirring surface of the grate. The cooling stirring tube is fixed on the reactor vessel. When the integrated grate rotates, the cooling stirring tube can stir the reacting material on the integrated grate and prevent the reacting biomass solid material from agglomerating. At the same time, cooling circulating water passes through the inside of the cooling stirring tube to prevent the temperature of the cooling stirring tube itself from being too high. A discharge gate is configured between the ash/char discharge unit and the integrated grate, which can better control the reaction process and the pile height of the material level is precisely controlled.

The vertical pyrolysis reactors in the prior art have problems such as inconvenient transportation, the need to be installed on-site and a long installation cycle, and the installation quality is difficult to control. However, the completely modular assembly of the bottom-feed pyrolysis reactor can be modularly manufactured and pre-installed in the equipment supplier's workshop, including electrical and monitoring systems, with comprehensive cold and hot tests, and then modularly transported to the site, shortening the time by 90% The on-site installation time also ensures the installation quality. The modular design greatly improves the level of commercialization. The integrated grate has the integrated functions of biomass feedstock feeding unit, air inlet unit, integrated grate rotation and ash/char discharge unit, while realizing pyrolysis. The reaction can be accurately controlled, and agglomeration can be completely monitored and removed, which solves the problems of inconvenient transportation, long installation period, and difficulty in controlling the installation quality of vertical pyrolysis reactors in the existing technology.

The completely modularly assembled lower feed pyrolysis reactor of the present invention includes a discharge gate unit, comprising: a flange ring, a plurality of discharge gate plates and a plurality of filling angle plates. The flange ring is connected to the bottom of the lower vessel, and the discharge gate plates are arranged horizontally and move along the radial direction of the flange ring to block the channel between the material moving surface of the integrated grate and the ash/char discharge hopper of the ash/char discharge unit. The filling angle plate is fixed on the inner ring of the flange ring. The filling angle plate fills the joint of the two discharge gate plates, the existence of the filling angle plate allows multiple discharge gate plates to move in the radial direction to change the on/off status between the integrated grate and the ash/char discharge unit. The filling angle plates fitted at the joint between the two discharge gate plates perfectly fill the gap, ensuring a complete closure.

The completely modularly assembled bottom-feed pyrolysis reactor of the present invention has a frame arranged at the work site to erect the reactor vessel. The platform of the frame can be connected with the lower vessel, the feeding unit, and the integrated grate, the ash/char discharge unit and the discharge gate unit are all integrated to achieve modular assembly, and are combined with the control system, electrical equipment, etc., and are sent to the installation site as a whole, which resolves the technical issues related to lengthy on-site installation times and difficulties in controlling the quality.

In the pyrolysis reactor described herein, the reactor vessel, the feeding unit, the integrated grate, the ash/char discharge unit and the discharge gate unit respectively correspond to the joints are all ring-shaped, allowing for modular assembly in any direction horizontally. This pyrolysis reactor, with its main modular components, can be assembled like building blocks. The direction of components such as feeding unit, air inlet unit, ash/char discharge unit and gas outlet unit can be combined in various configurations to meet the diverse needs of customers without changing the overall design of the pyrolysis reactor itself.

The multi-product cogeneration system of the present invention significantly increases processing capacity by configuring multiple pyrolysis reactors in parallel. When processing the same amount of biomass, each pyrolysis reactor achieves high precision in controlling the pyrolysis reaction conditions. Different types of biomass feedstock, such as rice husks, bamboo chips, sludge, plastic, or sawdust, can be simultaneously fed into different pyrolysis reactors. Each pyrolysis reactor can precisely control the pyrolysis reaction conditions, allowing for accurate adjustment of parameters such as temperature, pressure, and residence time; While providing pyrolysis gas fuel to the downstream combustion chamber, depending on the type of biomass, different pyrolysis reactors can be used to produce various types of biochar. For instance, bamboo char, wood char, rice husk char, coconut shell char, and walnut shell char can be obtained. These biochars have high market value and can be sold. However, certain types of biomass, such as municipal solid waste RDF, dried sludge, and organic waste, cannot produce char to sell due to environmental reasons, to produce ash instead. Multiple pyrolysis reaction units are interconnected to achieve redundancy. When some of the pyrolysis reactors are out of service due to repair or maintenance, the entire biomass pyrolysis reaction system can still continue to operate to ensure that the load requirements are maintained without interruption. Therefore, the customer's operation will not be affected. The above-mentioned requirements for realizing redundancy, simultaneous use of different biomass feedstock for each pyrolysis reactor, and adjustment of biochar production of each pyrolysis reactor are essential requirements for the commercialization of biomass energy.

### BRIEF DESCRIPTION OF THE DRAWINGS

FIG. 1 is a decomposition process diagram of the completely modularly assembled bottom-feed pyrolysis reactor of the present invention;

FIG. 2 is a partial schematic diagram of the pre-assembled, tested in manufacture plant, ready to be transported to the installation site package of the completely modularly assembled bottom feed pyrolysis reactor of the present invention;

FIG. 3 is a schematic cross-sectional view of the completely modularly assembled bottom-feed pyrolysis reactor of the present invention;

FIG. 4 is an exploded view of the completely modularly assembled bottom-feed pyrolysis reactor of the present invention;

FIG. 5 is a water circuit diagram of the cooling water circulation of the cooling stirring pipe of the completely modularly assembled bottom feed pyrolysis reactor of the present invention;

FIG. 6 is a perspective view of the discharge gate unit of the completely modularly assembled bottom feed pyrolysis reactor of the present invention;

FIG. 7 is a top view of the discharge gate unit of the completely modularly assembled bottom feed pyrolysis reactor of the present invention;

FIG. 8 is a schematic diagram of the completely modularly assembled bottom feed pyrolysis reactor of the present invention after being transported to the installation site after modular installation and debugging;

FIG. 9 is a modular schematic diagram of the completely modularly assembled bottom feed pyrolysis reactor of the present invention;

FIG. 10 is a schematic diagram of the completely modularly assembled bottom feed pyrolysis reactor of the present invention in the original configuration of the component direction;

FIG. 11 is a top view of the fully modularly assembled bottom feed pyrolysis reactor of the present invention in the original configuration of the component direction;

FIG. 12 is a schematic diagram of the completely modularly assembled bottom-feed pyrolysis reactor of the present invention when the direction of lower vessel door is adjusted;

FIG. 13 is a top view of the completely modularly assembled bottom feed pyrolysis reactor of the present invention when the direction of lower vessel door is adjusted;

FIG. 14 is a schematic diagram of the completely modularly assembled bottom feed pyrolysis reactor of the present invention when the direction of the gas outlet is adjusted;

FIG. 15 is a top view of the completely modularly assembled bottom feed pyrolysis reactor of the present invention after adjusting its gas outlet direction;

FIG. 16 is a schematic diagram of the completely modularly assembled bottom-feed pyrolysis reactor of the present invention after the directions of lower vessel door and gas outlet is adjusted;

FIG. 17 is a top view of the completely modularly assembled bottom feed pyrolysis reactor of the present invention after the directions of lower vessel door and gas outlet are adjusted.

In the present invention: 1-reactor vessel, 11-upper vessel, 12-lower vessel, 121-circulating water channel, 122-arch protrusion part, 123-agglomeration break ring; 2-feeding unit, 21-feeding pipe; 3-integrated grate, 31-material moving surface, 32-cooling stirring pipe; 4-ash/char discharge unit, 41-ash/char discharge hopper; 5-discharge gate unit, 51-flange ring, 52-discharge gate plate, 53-filling angle plate; 6-Platform frame body, 61-support leg; 7-shut off valve, 71-valve core, 72-valve stem; 8-vent pipe, 81-scrubbling tank; 9-observation port.

### DETAILED DESCRIPTIONS OF EMBODIMENTS

Referring now to the drawings wherein the showings are for purposes of illustrating embodiments of the article only and not for purposes of limiting the same, and wherein like reference numerals are understood to refer to like components:

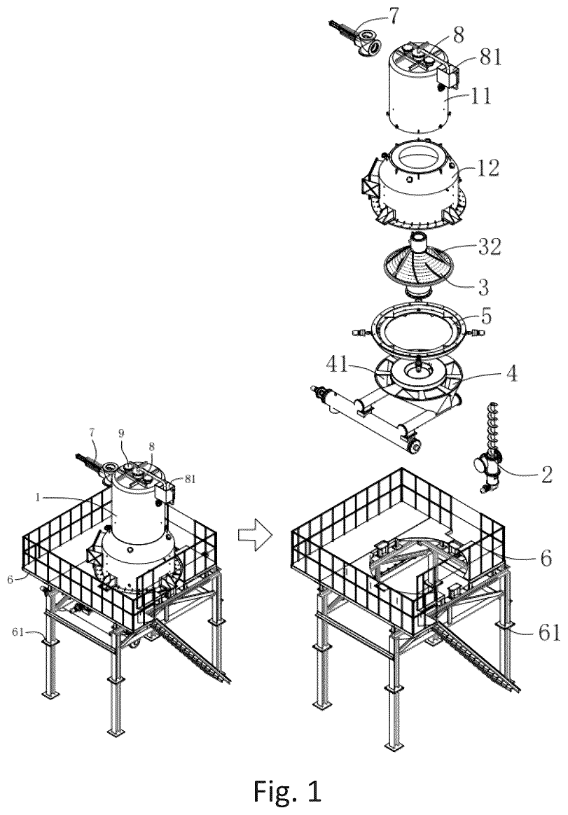

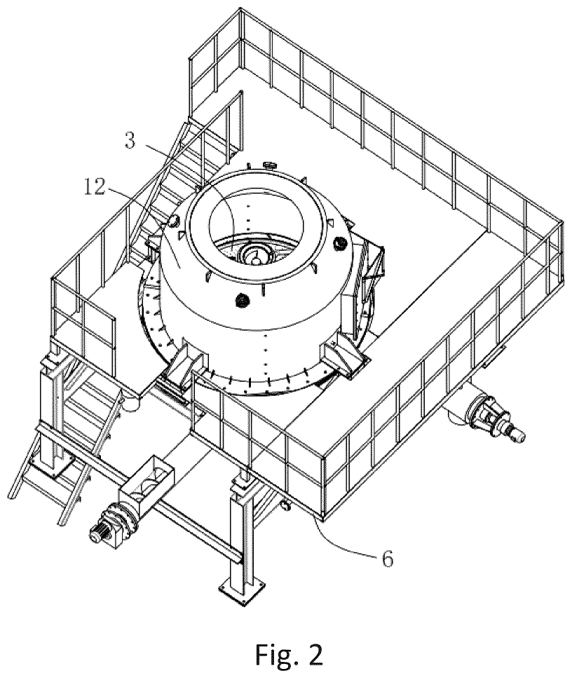

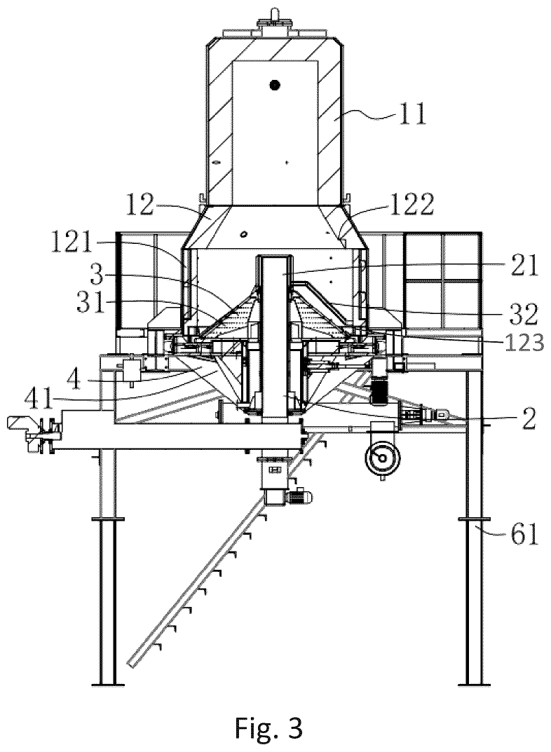

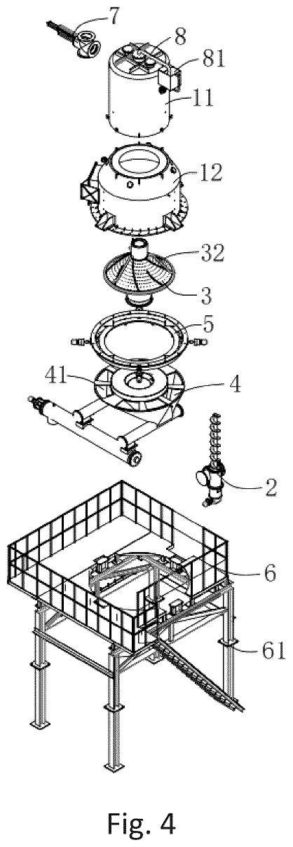

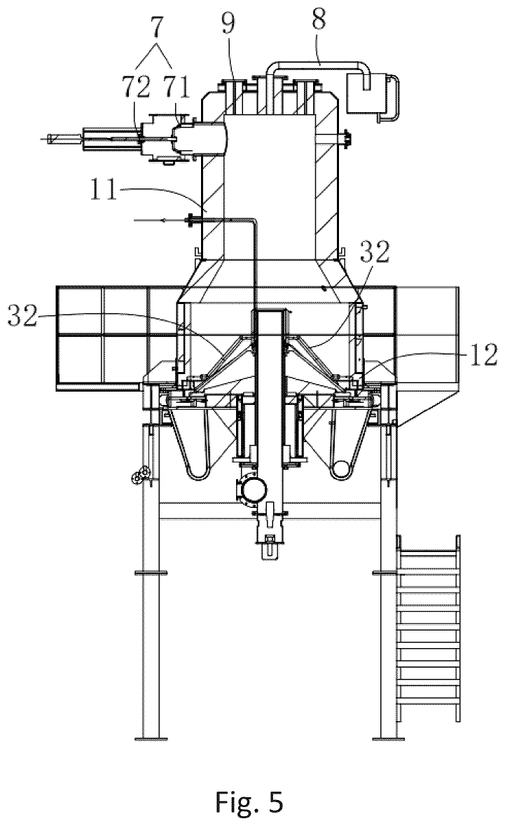

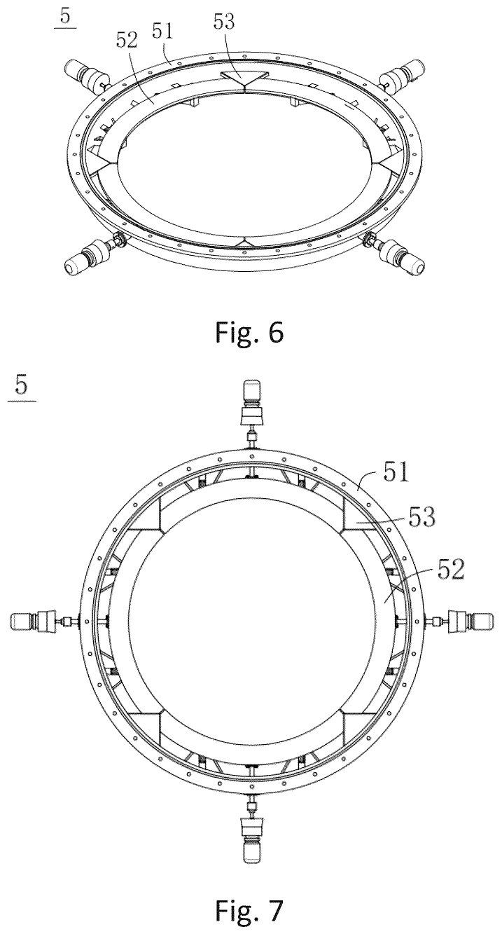

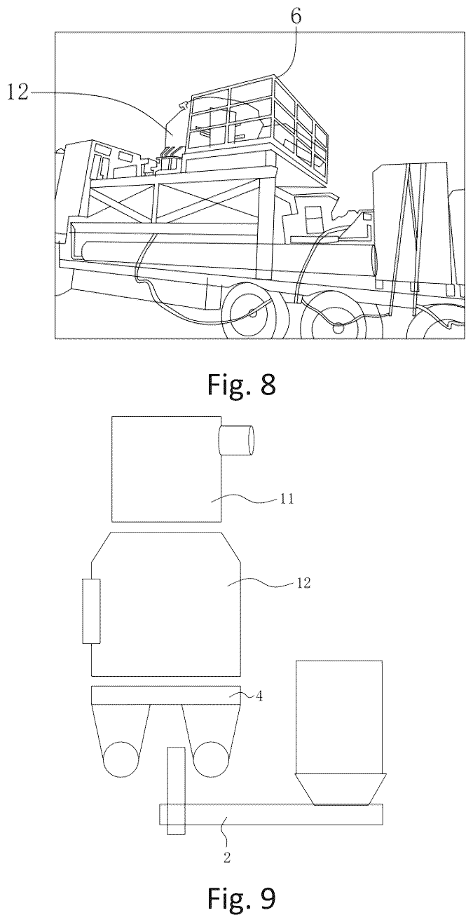

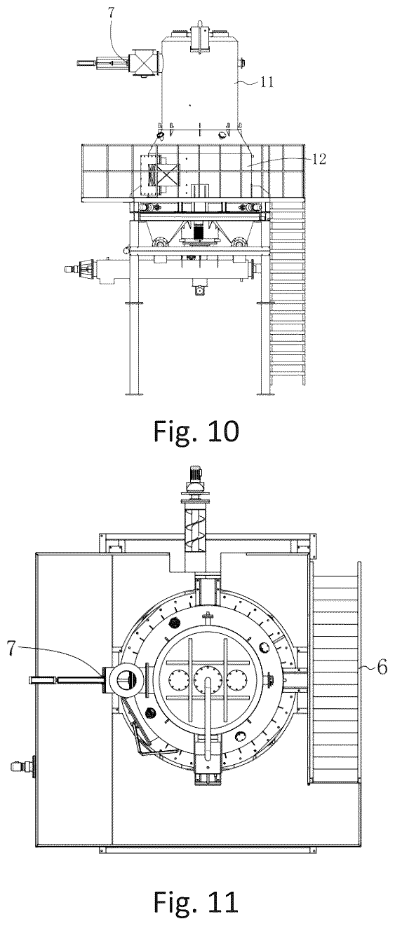

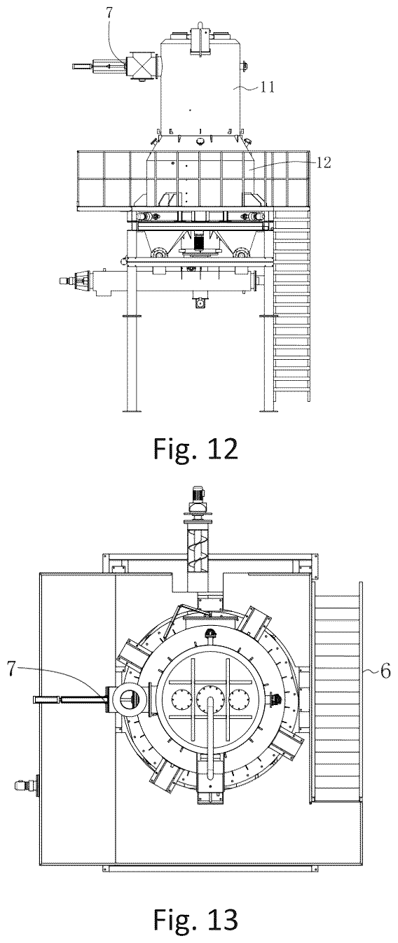

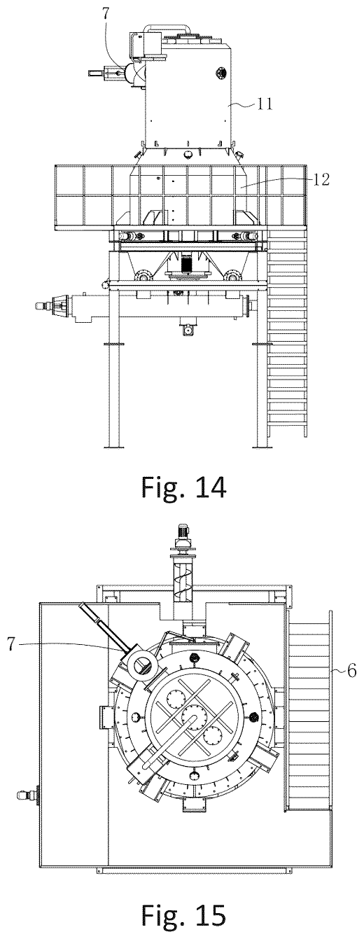

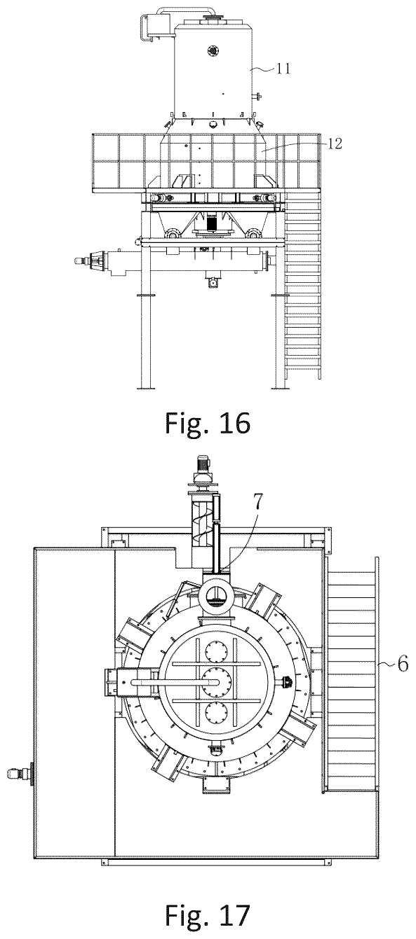

As shown in FIGS. 1-6, the present invention provides a completely modularly assembled bottom-feed pyrolysis reactor, including a reactor vessel 1, a feeding unit 2, an integrated grate 3, an ash/char discharge unit 4 and a discharge gate unit 5. The reactor vessel 1 includes a detachable upper vessel 11 and a lower vessel 12. The lower vessel 12, platform of a frame 6, bracket, monitoring equipment, integrated grate 3, etc. are integrated to complete the pre-assembly. After debugging by the manufacturer, it can be sent directly to the site for quick installation. The upper vessel 11 is made of steel shell and lightweight castable refractory material. Integrated with the integrated grate 3 the lower vessel 12 is made of steel shell and high-density hard castable refractory material. The feeding unit 2 is arranged at the lower vessel 12, and the integrated grate 3 is rotatably arranged inside the lower vessel 12 and is sleeved on the feed pipe 21 of the feeding device 2. A cooling stirring pipe 32, fixedly connected to the vessel 1, is arranged above the material moving surface 31 of the integrated grate 3. The water inlet and outlet of the cooling stirring pipe 32 are fixed on the reactor vessel 1. The integrated grate 3 is also connected to the air inlet unit, which can accurately control the air inlet volume, it is integrated with the feeding unit 2 and the ash/char discharge device 4 together and is the core components for completing the core functions of the pyrolysis reactor of this application. The integration maximizes the manufacturing level of assembly and quality control. The ash/char discharge unit 4 is fixedly connected to the lower vessel 12 through the integrated grate 3 and is located at the bottom of the integrated grate 3, forming an integral unit with the integrated grate 3. The discharge gate unit 5 is arranged between the integrated grate 3 and the ash/char discharge unit 4, allowing the residue generated on the material moving surface 31 of the integrated grate 3 to enter the ash/char discharge hopper 41 of the ash/char discharge unit 4 through the discharge gate unit 5, which is controlled by the on-off of discharge gate plates 52 capable of horizontal movement to achieve closure of the circular and strip-shaped outlet surface.

The completely modularly assembled bottom-feed pyrolysis reactor of the present invention includes the detachable upper vessel 11 and lower vessel 12 of the pyrolysis reactor, the feeding unit 2, the integrated grate 3 connected to the air inlet unit, and the ash/char discharge unit 4 and discharge gate unit 5, and the feeding device 2 are assembled on the lower vessel 12 and integrated with the integrated grate 3 to enable bottom-feed operation. Bottom-feed operation ensures uniform distribution of biomass materials on the surface of the integrated grate 3, which is a prerequisite for accurately controlling the pyrolysis reaction process. The integrated grate 3 is rotatably arranged inside the lower vessel 12 and is sleeved on the feeding pipe 21 of the feeding unit 2. The integrated grate 3 is connected to the air inlet unit so that the integrated grate 3 has an air inlet function. A cooling stirring pipe 32 is fixedly connected to the reactor vessel 1 above the material moving surface 31 of the integrated grate 3. The cooling stirring tube 32, fixedly connected to the reactor vessel 1, is located above the material moving surface 31 of the integrated grate 3, and its inlet and outlet are fixed to the reactor vessel 1. The ash/char discharge unit 4 is fixedly connected to the lower vessel 12. The ash/char discharge unit 4 is also integrated with the integrated grate 3. The integrated grate 3 integrates the feeding unit, air inlet unit and the ash/char discharge unit and transmission functions are integrated to achieve precise control of all process parameters of the pyrolysis reaction: feed rate, material pile height, air inlet rate, reaction rate, reaction temperature, reaction intensity, discharge rate, etc. In order to solve the existing problems of vertical pyrolysis reactors in the prior art such as inconvenient transportation, must be installed on-site, long installation period and difficult to control the installation quality, the pyrolysis reactor of this application is pre-installed by the manufacturer including electrical and monitoring system, and conduct comprehensive cold and hot debugging, and then transport it to the site in a modular manner, which shortens 90% of the on-site installation time while ensuring the installation quality. The modular installation also ensures that the direction of feed, air inlet, ash/char discharge and gas outlet can be adjusted at any time. When each modular equipment is standardized, cach installation angle can be adjusted like a combination of building blocks to suit the customer's on-site needs without changing the overall design of the pyrolysis reactor. In summary, the modular design greatly improves the level of commercialization. The integrated grate 3 with integrated functions of feeding, air supply, and rotation of the integrated grate 3, combined with precise control of the pyrolysis reaction, and the ability to fully monitor and remove agglomeration, solves the technical problems of excessive local temperature and biomass agglomeration inside the pile of the reactor.

In the present invention, the lower vessel 12 of the pyrolysis reactor forms a circulating water channel 121 inside its vessel wall for cooling water circulation. The circulating water channel 121 is arranged near the outer periphery of the lower vessel 12, which does not affect the internal reaction of the pyrolysis reactor and prevents the insulation casting refractory material of the lower vessel 12 from overheating, thereby avoiding material agglomeration, adhesion, and accumulation on the inner refractory surface.

In a specific embodiment of the present invention, the water inlet of the cooling stirring pipe 32 is arranged on the lower vessel 12, and the water outlet of the cooling stirring pipe 32 is arranged on the upper vessel 11. The cooling of the cooling stirring pipe 32 is achieved using circulating water that enters from the lower vessel 12 and flows from bottom to top. The cooling circulating water passes through the cooling stirring pipe 32 and above the integrated grate 3, converges to the feed port above the integrated grate 3, continues upward, and finally flows from the upper vessel leaving at the water outlet of upper vessel 11.

In a specific embodiment of the present invention, the connection between the top of the lower vessel 12 and the upper vessel 11 is gradually narrowed. In terms of technology, this narrowing can facilitate the mixing of pyrolysis gases generated at different times, and secondary processing. reaction. And there is an arched protrusion part 122 protruding into the reactor vessel 1 at the gradually narrowing diameter. In the internal space of the reactor vessel 1, materials are accumulated on the integrated grate 3, and the integrated grate 3 rotates, the material will rotate accordingly. When the material accumulates at the agglomeration break ring 123, it will be compressed by the agglomeration break ring and the accumulated state will be released, thus completely avoiding the possibility of hardening of biomass materials that are prone to agglomeration. This hardening can be monitored and predicted operating parameters, grate motor current, etc. After monitoring, the operating status of the integrated grate can be adjusted, such as increasing the rotation speed and operating time of the integrated grate, to break the hardening and ensure the smooth operation of the unit. Some biomass materials, such as dried sludge, are easy to agglomerate. The pyrolysis reactor of the present application can monitor, predict, and eliminate agglomeration to ensure the smooth operation of the unit. Compared to existing technology, reducing the downtime of the unit due to clogging and agglomeration to zero is a critical advancement in the industry. The procedures mentioned above can be executed by the control system, automatically determined, and carried out.

In a specific embodiment of the present invention, the discharge gate unit 5 includes a flange ring 51, a plurality of discharge gate plates 52 and a plurality of filling angle plates 53. The flange ring 51 is connected to the bottom of the lower vessel 12 and is arranged horizontally. The discharge gate plate 52 is arranged horizontally and moves in the radial direction of the flange ring 51 to block the material on the material moving surface 31 of the integrated grate 3 and the circular outlet surface of the ash/char discharge hopper 41 of the ash/char discharge unit 4. The filling angle plate 53 is fixed. In the inner ring of the flange ring 51, the filling angle plate 53 fills the joint of the two discharge gate plates 52. The existence of the filling angle plate 53 allows multiple discharge gate plates 52 to move in the radial direction to change the on/off status between the integrated grate 3 and the ash/char discharge unit 4, and the filling angle at the joint of the two discharge gate plates 52 is filled. The filling angle plate 53 just blocks the gap and achieves perfect closure.

Specifically, the vertical projection of the filling angle plate 53 forms an isosceles triangle. The bottom edge of the filler angle plate 53 is connected to the flange ring 51, and the two inclined edges of the filler angle plate 53 extend and converge toward the center of the flange ring 51. Correspondingly, the end of the discharge gate plate 52 is shaped to match the shape of the filler angle plate 53 to form a direct guiding angle.

In order to realize the radial movement of the discharge gate plate 52, each discharge gate plate 52 is driven by an independent motor or cylinder. When the motor is driven, a nut is fixed on the discharge gate plate 52, and a screw rod is fixed on the output shaft of the motor, which cooperates with the nut. The advantage of this driving method is that the driving device does not come into contact with the reacting material, is far away from the heat source, is not easily damaged, and has better stability.

In a specific embodiment of the present invention, the pyrolysis reactor also includes a frame 6. The frame 6 is arranged at the work site to erect the reactor vessel 1. The support legs 61 of the frame 6 are configured to be connected in sections. The height of the platform itself of the frame 6 is set to facilitate the installation of the ash/char discharge unit, but the support legs 61 that are too high are not conducive to transportation, so the support legs 61 are configured to be connected in sections to facilitate loading and transportation. The platform included in the frame 6 can be integrated with modular components such as the integrated grate 3, the lower vessel 12, the discharge gate unit 5, the ash/char discharge device 4, etc., and can be sent to the installation site in conjunction with the control system, electrical equipment, etc.

In a specific embodiment of the present invention, a shut-off valve 7 is also provided on the pyrolysis gas outlet pipe of the upper vessel 11. The shut-off valve 7 includes a valve core 71 and a valve stem 72. The sealing portion of the valve core 71 is opposite to the outlet of the gas outlet pipe of the upper vessel 11, and the valve stem 72 drives the valve core 71 away from or close to the outlet of the gas outlet pipe of the upper vessel 11. In the open state of the shut-off valve 7 the valve core 71 and the valve stem 72 move away from the outlet of the gas outlet pipe, reducing the influence of the heat source on the valve core 71 and the valve stem 72 and improving the stability of the shut-off valve 7.

In a specific embodiment of the present invention, the top of reactor vessel 1 is also equipped with a vent pipe or emergency vent unit 8 to ensure the safety of the reactor in emergency conditions. The emergency vent unit 8 is connected to a scrubbing pool 81 to prevent secondary pollution.

In a specific embodiment of the present invention, the corresponding connections of the reactor vessel 1, the feeding unit 2, the integrated grate 3, the ash/char discharge unit 4 and the discharge gate unit 5 corresponds to a circular ring joint, allowing modular assembly in any directions horizontally. The main modular components can be assembled in any direction and configuration like building blocks to meet diverse customer needs without altering the overall design of the pyrolysis reactor itself.

In a specific embodiment of the present invention, the three-dimensional space occupied by the lower vessel 12 of the reactor vessel 1, the feeding unit 2, the integrated grate 3, the ash/char discharge unit 4 and the discharge gate unit 5 after integration into a complete unit is less than or equal to the loading space of the loaded vehicle, so that the loaded vehicle can meet the requirements for road transportation. The main modular components, such as: lower vessel 12, integrated grate 3, platform and bracket of frame 6, discharge gate unit 5, ash/char discharge unit 4, etc. are connected to the control system, electrical wiring, etc. are installed and debugged well, its design size just meets all the requirements for road transportation. It is delivered to the site as a large module, which facilitates installation, shortens the installation time by 90% and ensures the installation quality.

Further, the top of the reactor vessel 1 can also be equipped with a plurality of observation ports 9, and sensors are arranged at the observation ports 9 to facilitate real-time control of the conditions inside the reactor.

Another aspect of the present invention also provides a multi-product cogeneration system, including the above-mentioned completely modularly assembled bottom-feed pyrolysis reactor. Further, it includes a combustion chamber and a plurality of the completely modularly assembled bottom-feed pyrolysis reactors, one or two of the completely modularly assembled bottom-feed pyrolysis reactors are in standby. The remaining fully modularly assembled bottom-feed pyrolysis reactors operate simultaneously, thereby achieving complete redundancy. This setup ensures continuous operation of the system without affecting the customers' required load similar to the arrangement of coal pulverizers and power plant boilers in thermal power plants.

The multi-product cogeneration system of the present invention, with multiple pyrolysis reactors set up in parallel, significantly increases processing capacity. When processing the same amount of biomass, each pyrolysis reactor maintains precise control over pyrolysis conditions. Different types of biomass feedstock can be fed into different pyrolysis reactors simultaneously, such as rice husks, bamboo shavings, dried sludge, plastics, or wood chips. Each pyrolysis reactor can precisely control the pyrolysis process parameters. By inputting different types of biomass into different reactors simultaneously, the system can produce different types of biochar, thereby improving the quality of the biochar. For example, some biomass feedstock types, such as bamboo char, wood char, rice husk char, coconut shell char, and walnut shell char, have high commercial value. However, other biomass types, such as municipal solid waste (RDF), dried sludge, and other organic solid waste, better not produce char due to environmental issues, produce ash instead. The multi-unit setup with redundant design ensures that the entire biomass pyrolysis system can continue to operate even when one of the pyrolysis reactors is down for maintenance or repair, thereby maintaining the required load and ensuring uninterrupted customer service. The redundancy backup, simultaneous use of different feedstock for each reactor, and adjusting of char production of each reactor are essential requirements for the commercialization of biomass energy.

What is claimed is:

1. A pyrolysis reactor, comprising:
a reactor vessel (1), comprising a detachable upper vessel (11) and a detachable lower vessel (12);
a feeding unit (2), provided at the lower vessel (12), the feeding unit (2), an air intake unit, and a discharge gate unit (5) being integrated with an integrated grate (3);
the integrated grate (3), rotatably provided inside the lower vessel (12), and fitted on a feeding pipe (21) of the feeding unit (2), a cooling stirring pipe (32) fixedly connected to the reactor vessel (1) being provided above a material moving surface (31) of the integrated grate (3), a water inlet nozzle and a water outlet of the cooling stirring pipe (32) being fixed to the reactor vessel (1), and the integrated grate (3) being connected to the air intake unit;
an ash/char discharge unit (4), fixedly connected to the lower vessel (12), provided at the bottom of the integrated grate (3), and integrated with the feeding unit (2) and the integrated grate (3);
the discharge gate unit (5), provided between the integrated grate (3) and the ash/char discharge unit (4) so that ash/char having reacted completely and present on the material moving surface (31) of the integrated grate (3) enters an ash/char discharge hopper (41) of the ash/char discharge unit (4) after passing through the discharge gate unit (5).

2. The pyrolysis reactor according to claim 1, wherein a circulating water channel (121) for circulating cooling water is formed in a housing wall of the lower vessel (12).

3. The pyrolysis reactor according to claim 1, wherein the water inlet nozzle of the cooling stirring pipe (32) is provided on the lower vessel (12), and the water outlet of the cooling stirring pipe (32) is provided on the upper vessel (11).

4. The pyrolysis reactor according to claim 1, wherein a join between the top of the lower vessel (12) and the upper vessel (11) is gradually narrowed, and an arch protrusion part (122) protruding into the reactor vessel (1) is formed in a tapered position narrowed gradually.

5. The pyrolysis reactor according to claim 1, wherein the discharge gate unit (5) comprises:
a flange ring (51), connected to the bottom of the lower vessel (12) and configured to be horizontal;
a plurality of discharge gate plates (52), configured to be horizontal and for moving in a radial direction of the flange ring (51) to perform blocking between the material moving surface (31) of the integrated grate (3) and a circular strip-shaped outlet surface of the ash/char discharge hopper (41) of the ash/char discharge unit (4); and
a plurality of filling angle plates (53), fixed to an inner ring of the flange ring (51) and filling a joint between the two discharge gate plates (52).

6. The pyrolysis reactor according to claim 5, wherein a vertical projection of the filling angle plate (53) is an isosceles triangle, a bottom line of the filling angle plate (53) being connected to the flange ring (51), two side lines of the filling angle plate (53) extending and converging towards the center of the flange ring (51), and correspondingly, a flat bevel matching the shape of the side line of the filling angle plate (53) being formed on an end portion of the valve plate (52).

7. The pyrolysis reactor according to claim 6, wherein each discharge gate plate (52) is driven by a separate motor or air cylinder.

8. The pyrolysis reactor according to claim 7, wherein when the discharge gate plate (52) is driven by the motor, a nut is fixed to the discharge gate plate (52), a lead screw fixed to an output shaft of the motor, and the lead screw cooperating with the nut.

9. The pyrolysis reactor according to claim 1, further comprising a frame body (6) for being arranged at a work site to support the reactor housing (1), a support leg (61) of the frame body (6) being configured to be formed by connecting segments, and the frame body (6) being capable of being integrated with the lower vessel (12), the feeding unit (2), the integrated grate (3), the ash/char discharge unit (4), and the discharge gate unit (5) to achieve modular assembly.

10. The pyrolysis reactor according to claim 1, wherein a shut-off valve (7) is further provided on a gas outlet pipe of the upper vessel (11), and comprises:
a valve core (71), a sealing portion of the valve core (71) facing an outlet of the gas outlet pipe of the upper vessel (11); and
a valve stem (72), for pushing the valve core (71) to move away from or approach the outlet of the gas outlet pipe of the upper vessel (11).

11. The pyrolysis reactor according to claim 1, wherein a top of the reactor vessel (1) is further provided with an emergency vent unit (8) connected into a scrubbing tank (81).

12. The pyrolysis reactor according to claim 1, wherein respective corresponding joins of the reactor vessel (1), the feeding unit (2), the integrated grate (3), the ash/char discharge unit (4), and the discharge gate unit (5) each are a ring fit, so as to achieve modular assembly horizontally in any direction.

13. The pyrolysis reactor according to claim 1, wherein after the lower vessel (12) of the reactor vessel (1), a frame body (6), the feeding unit (2), the integrated grate (3), the ash/char discharge unit (4), and the discharge gate unit (5) are pre-assembled completely to be integrated into a whole, a three-dimensional space occupied thereby is smaller than or equal to a loading space of a loading vehicle, so that the loaded vehicle satisfies road transportation requirements.

14. A multi-product co-generation system, comprising the pyrolysis reactor according to claim 1.

15. The multi-product co-generation system according to claim 14, comprising a combustion chamber and a plurality of pyrolysis reactors, wherein one or two of the plurality of pyrolysis reactors are standbys, and the remaining pyrolysis reactors operate normally at the same time.
